(19) United States
(12) Patent Application Publication
(10) Pub. No.: US 2022/0084379 A1
(43) Pub. Date: Mar. 17, 2022

(54) VIDEO PRE-RECORDING METHOD, VIDEO CAMERA AND ELECTRONIC DEVICE

(71) Applicant: Shenzhen Reolink Technology Co., Ltd., Shenzhen (CN)

(72) Inventor: Yuan HUANG, Shenzhen (CN)

(21) Appl. No.: 17/335,061

(22) Filed: May 31, 2021

(30) Foreign Application Priority Data
Sep. 14, 2020 (CN) 202010963713.3

(51) Int. Cl. G08B 13/196; H04N 5/232

(52) U.S. Cl. CPC G08B 13/19652; H04N 5/232411; G08B 13/19669; G08B 13/19676

(57) ABSTRACT

This application discloses a video pre-recording method and video camera, and an electronic device. The video pre-recording method includes: adding a pre-alarm area on a periphery of an alarm area; when occurrence of a predefined event in the pre-alarm area is detected, switching the video camera from a standby state to an operation state, and starting recording to obtain a first video; maintaining the video camera in the operation state, and detecting whether a predefined event occurs in the alarm area; and if occurrence of the predefined event in the alarm area is detected, taking a preset duration of the first video as a pre-recorded video of a second video, where the second video has a starting time that is the same as a time when the predefined event occurs in the alarm area. Based on this, this application can enable low-power video cameras to perform a video pre-recording function.

### CROSS-REFERENCE TO RELATED APPLICATIONS

The present application claims priority from the Chinese Invention Patent Application No. 202010963713.3 filed on Sep. 14, 2020, and the disclosure of which is incorporated herein by reference in its entirety.

### FIELD OF THE INVENTION

The present application relates to the technical field of video capture and security, and in particular, to a video pre-recording method and a video camera, an electronic device based on the same.

### BACKGROUND OF THE INVENTION

In a digital video surveillance system, a pre-recording function may be used to record video information during a period of time before and after the occurrence of an emergency. It is unnecessary to save the pre-recorded video data when there is no emergency, and it is necessary to save the pre-recorded video data only when an emergency occurs. The pre-recording function allows the video surveillance system not to record video contents over the whole period of surveillance, which can save a lot of storage space and reduce costs.

With the advancement and development of the security technology and industry, a large number of new-type network cameras have emerged on the market nowadays. A common type is a battery-powered merely-wireless low-power video camera. Such type of video camera is in a standby state most of the time instead of operating 7*24 hours to record videos continuously. Once an emergency is detected, the system is quickly awakened and starts recording. Since the system is not in operation before an alarm, pre-recording cannot be implemented, but users often also want to know the situation within a period of time before the alarm, and therefore it is necessary to implement pre-recording.

The foregoing description is to provide general background information and does not necessarily constitute the prior art.

### SUMMARY OF THE INVENTION

In view of above issues, the present application provides a video pre-recording method and video camera, and an electronic device, so as to solve the problem that existing low-power video cameras cannot achieve video pre-recording.

A video pre-recording method provided in this application includes: adding a pre-alarm area on a periphery of an alarm area; when occurrence of a predefined event in the pre-alarm area is detected, switching a video camera from a standby state to an operation state, and starting recording to obtain a first video; maintaining the video camera in the operation state, and detecting whether the predefined event occurs in the alarm area; and if occurrence of a predefined event in the alarm area is detected, taking a preset duration of the first video as a pre-recorded video of a second video, where the second video has a starting time that is the same as a time when the predefined event occurs in the alarm area.

Optionally, the method further includes storing the first video in a system buffer; and writing the first video to a hardware storage medium when occurrence of the predefined event in the alarm area is detected.

Optionally, the method further includes deleting the first video stored in the system buffer when disappearance of the predefined event from the alarm area is detected.

Optionally, the method further includes configuring a first detector to detect whether the predefined event occurs in the pre-alarm area; and configuring a second detector to detect whether the predefined event occurs in the alarm area.

Optionally, the method further includes configuring a single detector, in an initial state, to have a monitoring area covering the pre-alarm area, and detecting whether the predefined event occurs in the pre-alarm area; and when occurrence of the predefined event in the pre-alarm area is detected, adjusting a monitoring view angle of the single detector to control the monitoring area to cover the alarm area.

A video camera provided in this application includes a detecting apparatus; wherein a view finding area of the video camera includes an alarm area and a pre-alarm area; the detecting apparatus is configured to detect whether a predefined event occurs in the alarm area and the pre-alarm area, and when occurrence of the predefined event in the pre-alarm area is detected, the video camera is switched from a standby state to an operation state and starts recording to obtain a first video, and then the video camera is maintained in the operation state, and the detecting apparatus detects whether the predefined event occurs in the alarm area, and if occurrence the predefined event in the alarm area is detected, the video camera takes a preset duration of the first video as a pre-recorded video of a second video, where the second video has a starting time that is the same as a time when the predefined event occurs in the alarm area.

Optionally, the video camera includes a hardware storage medium, where the first video is stored in a system buffer of the video camera, and is written to the hardware storage medium when occurrence of the predefined event in the alarm area is detected.

Optionally, the detecting apparatus includes a first detector and a second detector, wherein the first detector is configured to detect whether the predefined event occurs in the pre-alarm area, and the second detector is configured to detect whether the predefined event occurs in the alarm area.

Optionally, the detecting apparatus includes a single detector. In an initial state, a monitoring area of the single detector covers the pre-alarm area, and the detector is configured to detect whether the predefined event occurs in the pre-alarm area; and when occurrence of the predefined event in the pre-alarm area is detected, a monitoring view angle of the single detector is adjusted to control the monitoring area to cover the alarm area.

An electronic device provided in this application includes a memory and a processor, where the memory is configured to store a program; and the processor is configured to execute the program to perform any of the above video pre-recording methods.

In this application, the pre-alarm area is added on the periphery of the alarm area, and a video is obtained through recording when a predefined event occurs in the pre-alarm area. That is, the video camera has already captured a preset duration of the video before the predefined event occurs in the alarm area, so that the video pre-recording can be implemented.

### BRIEF DESCRIPTION OF THE DRAWINGS

To describe the technical solutions in the embodiments of this application more clearly, the following briefly describes accompanying drawings required for describing the embodiments. Apparently, the accompanying drawings in the following description show merely some embodiments of this application, and a person skilled in the art may still derive other drawings from these accompanying drawings without creative efforts.

FIG. 1 is a schematic flowchart of a video pre-recording method according to an embodiment of this application.

FIG. 2 is a schematic diagram of a first scenario of performing video pre-recording based on the method shown in FIG. 1.

FIG. 3A is a schematic diagram of a second scenario of performing video pre-recording based on the method shown in FIG. 1.

FIG. 3B is a schematic diagram of a third scenario of performing video pre-recording based on the method shown in FIG. 1.

FIG. 4 is a schematic diagram of a fourth scenario of performing video pre-recording based on the method shown in FIG. 1.

FIG. 5 is a schematic diagram of a time course of performing video pre-recording based on the method shown in FIG. 1.

FIG. 6 is a schematic structural diagram of a video camera according to an embodiment of this application; and

FIG. 7 is a schematic structural diagram of a video camera according to another embodiment of this application.

### DETAILED DESCRIPTION

The following clearly and thoroughly describes the technical solutions in the embodiments of this application with reference to the accompanying drawings. Apparently, the described embodiments are merely some but not all of the embodiments of this application. All other embodiments obtained by a person skilled in the art based on the embodiments of this application without creative efforts shall fall within the protection scope of this application. The following embodiments and features in the embodiments may be mutually combined in case that no conflict occurs.

It should be noted that in the description of the specification, steps are represented by S11 and S12. The purpose is to describe the corresponding content more clearly and briefly, and does not constitute a substantial restriction on the sequence. During specific implementation by those skilled in the art, S12 may be performed first and then S11, and so on, but these should all fall within the protection scope of this application.

Existing low-power video cameras cannot achieve video pre-recording. For this, an embodiment of this application provides a video pre-recording method. A pre-alarm area is added on the periphery of an alarm area, and a video is captured when a predefined event occurs in the pre-alarm area. That is, the video camera has already captured a preset duration of the video before the predefined event occurs in the alarm area, so that the video pre-recording can be implemented.

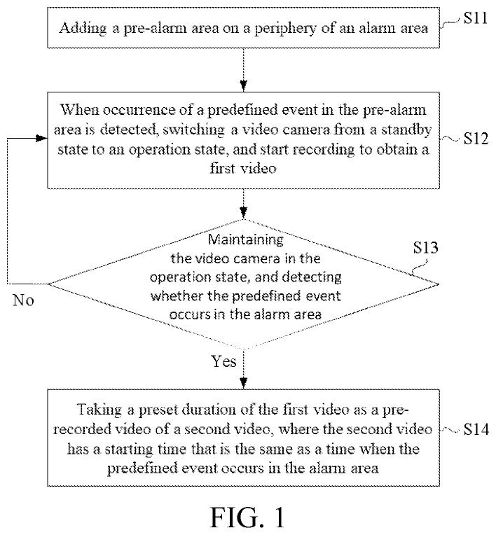

FIG. 1 is a schematic flowchart of a video pre-recording method according to an embodiment of this application. Referring to FIG. 1, the video pre-recording method includes the following steps S11-S14.

S11: Adding a pre-alarm area on a periphery of an alarm area.

The alarm area may be regarded as an area where a traditional low-power video camera monitors. Once an emergency in the alarm area is detected, the traditional low-power video camera starts recording.

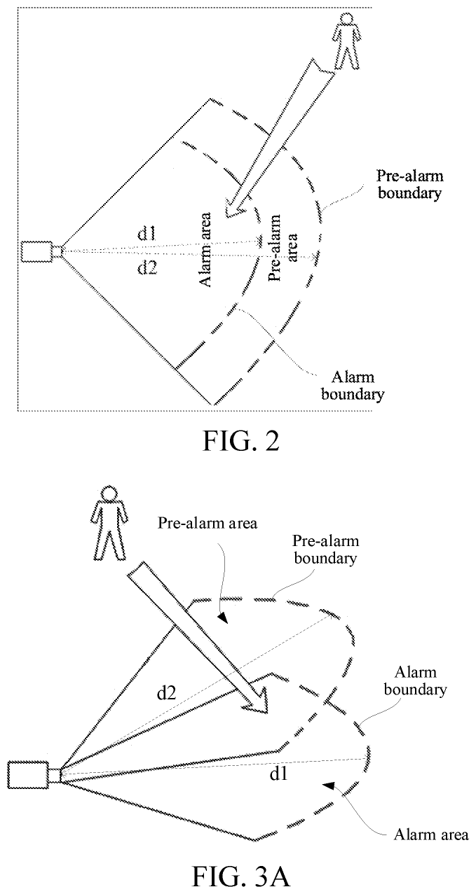

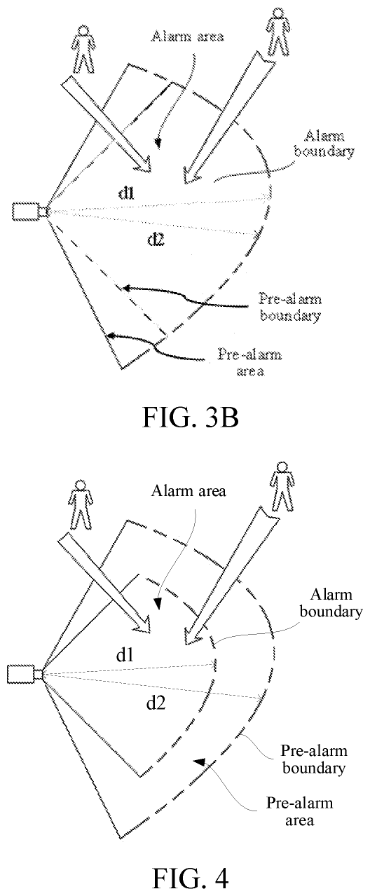

As shown in FIG. 2, FIG. 3A, FIG. 3B, and FIG. 4, the pre-alarm area is disposed immediately on the periphery of the alarm area, which is equivalent to an extension of the periphery of the traditional alarm area. Once an emergency in the pre-alarm area is detected, the video camera (including the traditional low-power video camera) will start recording.

The pre-alarm area is disposed on the periphery of the alarm area such that a person has to enter the pre-alarm area before entering the alarm area.

S12: When occurrence of a predefined event in the pre-alarm area is detected, switching a video camera from a standby state to an operation state, and start recording to obtain a first video.

The predefined event may be regarded as the emergency that is usually described in the art, which may trigger a motion detection alarm or an input/output (IO) alarm. The motion detection alarm indicates an abnormal event that suddenly occurs in a video surveillance area, for example, some unexpected people or object suddenly intrudes, or the like. The IO alarm refers to an abnormal situation that some monitoring data of the video camera exceeding a warning range (or a warning threshold), for example, an excessively fast speed, insufficient fuel, fatigue driving, reversing, or the like in a vehicle-mounted video system.

As an example, in a particular scenario where a person intruding, as shown in FIG. 2 to FIG. 4, once the person crosses a boundary between a visible area and the pre-alarm area of the video camera (also referred to as a pre-alarm boundary), it may be deemed that the predefined event is detected to occur in the pre-alarm area. At this time, the video camera is switched from the standby state to the operation state, and starts recording to obtain a first video.

S13: Maintaining the video camera in the operation state, and detecting whether the predefined event occurs in the alarm area.

Referring to FIG. 2 to FIG. 4, once the person crosses a boundary between the pre-alarm area and the alarm area of the video camera (also referred to as an alarm boundary), it may be deemed that the predefined event is detected to occur in the alarm area. Correspondingly, if the person does not enter the alarm area, for example, the person is staying in the pre-alarm area, or the person is moving back and forth between the visible area and the pre-alarm area, it may be deemed that no predefined event occurs in the alarm area in the embodiment of this application.

If it is detected that a predefined event occurs in the alarm area, step S14 is performed; and if it is not detected that a predefined event occurs in the alarm area, then the detection is continued, that is, step S12 is to be performed.

S14: Taking a preset duration of the first video as a pre-recorded video of a second video, where the second video has a starting time that is the same as a time when the predefined event occurs in the alarm area.

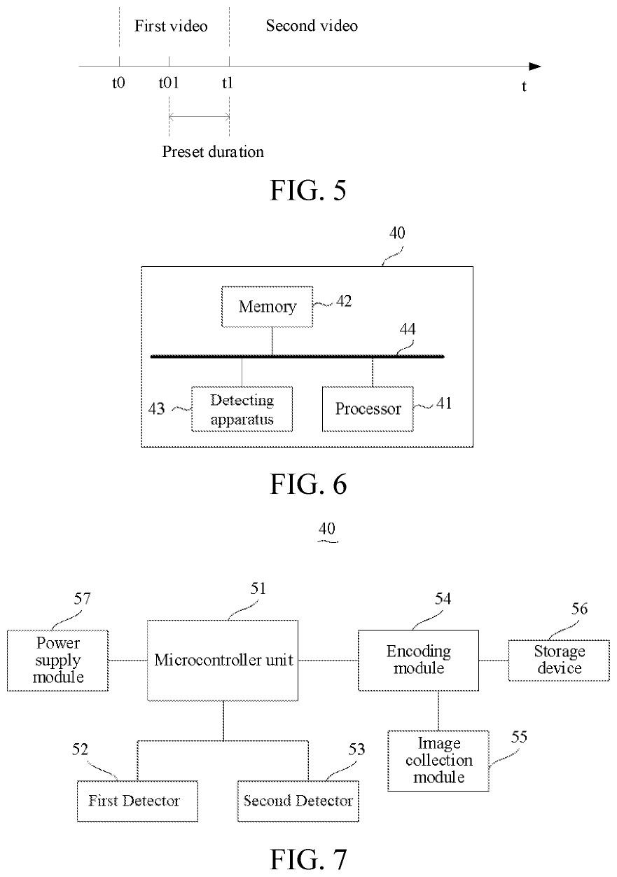

Referring to FIG. 5, the first video has a starting time t0 which is the same as a time when the predefined event occurs in the pre-alarm area, and an ending time t1 which is the same as a time when the predefined event occurs in the alarm area; and the ending time t1 of the first video is a starting time of the second video.

A starting time t01 of the preset duration may be customized by the user. The starting time t01 of the preset duration is the starting time of the pre-recorded video, and the starting time t1 of the second video is the ending time of the pre-recorded video.

Based on the above, in the embodiments of this application, the video camera has already captured the video with the preset duration (which can be part of the duration of the first video or the whole duration of the first video) before the predefined event occurs in the alarm area, so that the video pre-recording is implemented.

In a specific scenario, the video camera can allocate a part of its memory space as a buffer (also referred to as a system buffer) for storing pre-recording videos. Here, the first video is stored in the system buffer. When a predefined event occurs in the alarm area, the video camera immediately writes the data stored in the system buffer (e.g. the first video) to a hardware storage medium, for example, a solid-state disc (SSD) or an external storage device. In the hardware storage medium, a preset duration of the first video (i.e. the pre-recording video) and the second video are integrated to generate a video file with pre-recorded video content.

If disappearance of the predefined event from the alarm area is detected, for example, the person leaves the alarm area, the recording of the emergency event may be stopped, the low-power video camera returns to the standby state. Further, the first video stored in the system buffer is deleted to release the memory.

One of the key points for implementing the video pre-recording method is how to implement the monitoring and alarming of the pre-alarm area. In this regard, the embodiments of this application provide the following two methods.

The first method is to add a pre-alarm detector to a video camera that has an alarm detector. In other words, the video camera integrates a first detector and a second detector. The first detector may be regarded as an existing alarm detector for the low-power video camera, and the second detector is an additional pre-alarm detector. The first detector and the second detector are configured to respectively detect whether the predefined event occurs in the pre-alarm area and the alarm area.

Since the pre-alarm area is disposed on the periphery of the alarm area, a detectable area of the second detector covers at least a detectable area of the first detector. To achieve this, the detectable areas of the second detector and the first detector can adopt three monitoring scenarios shown in FIG. 2, FIG. 3A, FIG. 3B, and FIG. 4.

Referring to FIG. 2, the first detector and the second detector have the same monitoring view angle and different monitoring distances, and a monitoring distance d2 of the second detector is greater than a monitoring distance d1 of the first detector.

The monitoring directions of the detectors may be adjusted through their mounting angles. Accordingly, the mounting angles of the two detectors are kept to be the same in this embodiment, for example, by mounting to the same plane of the video camera and closely adjacent to each other, thereby causing the monitoring directions of the two detectors to overlap.

Each of the detectors mainly includes two parts: a sensor and a lens assembly. The sensor sensitivity, the lens material, refractive index and area may affect the monitoring distance of the detector. Accordingly, in the embodiment of this application, the monitoring distance d2 of the second detector can be greater than the monitoring distance d1 of the first detector through the design of the sensor and the lens assembly.

Referring to FIG. 3A, the first detector and the second detector have different monitoring directions, the same monitoring view angle and the same monitoring distance, and the monitoring distance d2 of the second detector is equal to the monitoring distance d1 of the first detector.

Optionally, the mounting plane of the first detector is tilted upwards with respect to the mounting plane of the second detector. Here, the detectable area of the first detector is within the detectable area of the second detector, and radii of curvature (that is, radians) of boundaries of the detectable areas of the two detectors are the same.

Referring to FIG. 3B, the first detector and the second detector have different monitoring view angles, the same monitoring direction and the same monitoring distance, and the monitoring distance d2 of the second detector is equal to the monitoring distance d1 of the first detector.

Optionally, the monitoring view angle of the first detector is greater than the monitoring view angle of the second detector. Here, the detectable area of the first detector is within the detectable area of the second detector.

Referring to FIG. 4, the first detector and the second detector have different monitoring view angles and different monitoring distances, and the monitoring distance d2 of the second detector is greater than the monitoring distance d1 of the first detector.

Compared with the scenario in FIG. 2, the pre-alarm area in this scenario has a larger range.

The second method is to provide only a single detector for the video camera, and to implement the pre-alarm area and the alarm area by adjusting the monitoring direction of the single detector. Specifically, in an initial state, the monitoring area of the single detector is controlled to cover the pre-alarm area, and it is detected whether a predefined event occurs in the pre-alarm area. When occurrence of the predefined event in the pre-alarm area is detected, the monitoring direction of the single detector is adjusted to control the monitoring area of the single detector to cover the alarm area.

In a specific scenario, the sensor and the lens assembly of the detector are fixed before leaving the factory. Therefore, the monitoring distance and view angle of the detector is not easy to adjust. As a result, in this embodiment, the monitoring direction of the detector can be adjusted by means of, for example, a motor, so as to implement the scenario described in FIG. 3A.

Specifically, when a predefined event does not occur, the monitoring direction of the single detector is adjusted to implement a pre-alarm area covered by the second detector as shown in FIG. 3A, and when the predefined event is detected, the monitoring direction of the single detector is adjusted to have an alarm area covered by the first detector as shown in FIG. 3A. The monitoring direction of the single detector is still adjusted to have the pre-alarm area covered by the second detector as shown in FIG. 3A when the predefined event disappears.

The type of any of the above detectors (including one of the first detector, the second detector, and the single detector) is not limited to the embodiments of this application. For example, the detectors may be any detecting apparatus based on the passive infrared (PIR) technology.

FIG. 6 is a schematic structural diagram of a video camera according to an embodiment of this application. Referring to FIG. 6, a video camera 40 includes a processor 41, a memory 42, and a detecting apparatus 43, and data or signal transmission connection between the three can be implemented through a communication bus 44.

The processor 41 is a control center of the video camera 40, and is connected to various parts of the video camera by using various interfaces and lines. The processor 41 performs various functions and data processing of the video camera 40 by running or loading program stored in the memory 42, and invoking the data stored in the memory 42, thereby performing overall control of the video camera.

The processor 41 loads instructions corresponding to processes of one or more programs into the memory 42 according to predetermined steps, and the processor 41 executes the program stored in the memory 42, thereby implementing the steps in the method of any of the above embodiments.

For the specific implementation of the steps, that is, for the specific content of the steps performed by the processor 41 when running the program, reference may be made to the above embodiment, and details are not described herein again.

It should be understood that during specific implementation in actual application scenarios, depending on the device type to which the video camera 40 belongs, the steps of the above video pre-recording method may not be performed by the processor 41 and the memory 42, but are implemented respectively by other modules and units, for example, as shown in FIG. 7.

FIG. 7 is a schematic structural diagram of a video camera according to another embodiment of this application. Referring to FIG. 7, the video camera 40 includes a microcontroller unit (MCU) 51, a first detector 52, a second detector 53, an encoding module 54, an image collection module 55, a storage device 56, and a power supply module 57.

The power supply module 57 supplies power to the entire video camera 40 under the control of the microcontroller unit 51.

The microcontroller unit 51 is a control center of the video camera 40, which connects various parts of the entire video camera 40 by using various interfaces and lines, performs various functions and processes data by running or loading a program and invoking data, thereby performing overall monitoring of the video camera 40.

The image collection module 55 is used for video recording, and may include an image sensor, an infrared lamp, and a filter respectively connected to the encoding module 54. A view finding area includes an alarm area and a pre-alarm area.

The first detector 52 and the second detector 53 are respectively configured to detect whether the predefined event occurs in the alarm area and the pre-alarm area.

When occurrence of a predefined event in the pre-alarm area is detected, the microcontroller unit 51 is switched from a standby state to an operation state, the encoding module 54 is simultaneously started, the image collection module 55 starts recoding to obtain the first video, and then the video camera remains the operation state. The encoding module 54 writes the first video to the system buffer of the video camera, and always keeps the video data as latest data for a period of time.

When the second detector 53 detects that a predefined event occurs in the alarm area, the encoding module 54 obtains the video in the system buffer, and takes a preset duration of the first video as a pre-recorded video of a second video, wherein the second video has a starting time that is the same as a time when the predefined event occurs in the alarm area.

The storage device 56 serves as a hardware storage medium, for example, may be an SD card. In the storage device 56, the preset duration of the first video and the second video are integrated to generate a video file with pre-recorded video content.

When the predefined events detected by the first detector 52 and the second detector 53 disappear, the microcontroller unit 51 controls the encoding module 54 and the image collection module 55 to stop recording, and the encoding module 54 is powered off, and the microcontroller unit 51 enters the standby state, that is, enters a low-power mode.

Certainly, in other embodiments, the video camera 40 may be integrated with a single detector. The single detector integrates the functions of the first detector 52 and the second detector 53.

An embodiment of this application further provides an electronic device, including a memory and a processor, where the memory stores a program which, when executed by the processor, causes the processor to implement any of the video pre-recording methods provided in the embodiments of this application. For details, reference is made to the foregoing embodiments, and details are not described herein again.

A person of ordinary skill in the art may understand that, all or some steps of the methods in the foregoing embodiments may be implemented by using instructions, or implemented through instructions controlling relevant hardware, and the instructions may be stored in a readable storage medium and loaded and executed by a processor. To this end, an embodiment of this application provides a readable storage medium storing a program, and the program can be loaded by a processor to perform one or more steps in any one of the video pre-recording methods according to the embodiments of this application.

The readable storage medium may include a read-only memory (ROM), a random-access memory (RANI), a magnetic disc, an optical disc, or the like.

Because the programs stored in the readable storage medium may perform one or more steps of any video pre-recording method in the embodiments of this application, the instructions can achieve beneficial effects that may be achieved by any video pre-recording method in the embodiments of this application. For details, refer to the foregoing embodiments. Details are not described herein again.

An embodiment of this application further provides a computer program product. The computer program product includes computer program code, and when the computer program code runs on a computer, the computer is enabled to perform the method in any possible implementation.

An embodiment of this application further provides a chip, comprising a memory and a processor. The memory is configured to store a computer program. The processor is configured to invoke the computer program from the memory and run the computer program, so that a device on which the chip is installed performs the method in any possible implementation.

It should be noted that terms “include”, “comprise”, and any variants thereof are intended to cover a non-exclusive inclusion. Therefore, in the context of a process, method, object, or apparatus that includes a series of elements, the process, method, object, or apparatus not only includes such elements, but also includes other elements not specified expressly, or may include inherent elements of the process, method, object, or apparatus. Without more restrictions, the element defined by the sentence “including a . . . ” does not exclude presence of other same elements in the process, method, article, or apparatus that includes the element. In addition, components, features, and elements with the same name in different embodiments may have the same meaning or different meanings, and their specific meanings need to be determined according to their explanations in the specific embodiment or further with reference to the context in the specific embodiment.

In addition, although terms such as first, second, and third may be used in this application to describe various information, the information should not be limited to these terms. These terms are merely used to distinguish between information of the same type. For example, without departing from the scope of this application, first information may also be referred to as second information, and similarly, depending on the context, second information may also be referred to as first information. The term “if” may be interpreted as “during” or “when” or “in response to determining.” Furthermore, as used herein, singular forms “a”, “an” and “the” are intended to also include plural forms, unless specified in the context to the contrary. The terms “or” and “and/or” are interpreted as inclusive, or mean any one or any combination. Therefore, “A, B, or C” or “A, B, and/or C” means “any of the following: A; B; C; A and B; A and C; B and C; A, B, and C”. An exception to this definition may occur only when the combination of elements, functions, steps, or operations is inherently mutually exclusive in some way.

Further, although the steps in the flowchart are sequentially shown according to indication of an arrow, the steps are not necessarily sequentially performed according to a sequence indicated by the arrow. Unless explicitly specified in this specification, execution of the steps is not strictly limited in the sequence, and the steps may be performed in other sequences. In addition, at least some steps in the accompanying drawings may include a plurality of substeps or a plurality of stages. The substeps or the stages are not necessarily performed at the same moment, but may be performed at different moments. The substeps or the stages are not necessarily performed in sequence, but may be performed in turn or alternately with another step or at least some of substeps or stages of the another step.

Although this application has been shown and described relative to one or more implementations, a person skilled in the art may come up with equivalent variations and modifications based on reading and understanding of the specification and the accompanying drawings. This application includes all such modifications and variations, and is supported by the technical solutions of the foregoing embodiments. That is, what is described above is merely some embodiments of this application, and does not thereby limit the patentable scope of this application. Equivalent structure transformation made by using the content in the specification or the accompanying drawings in this application, for example, the technical features in the embodiments may be combined with each other, whether directly or indirectly applied to other related technical fields, are similarly covered by the patent protection scope of this application.

What is claimed is:

1. A video pre-recording method, comprising:
adding a pre-alarm area on a periphery of an alarm area;
configuring a single detector, in an initial state, to have a monitoring area covering the pre-alarm area,
detecting whether a predefined event occurs in the pre-alarm area;
when occurrence of a predefined event in the pre-alarm area is detected;
adjusting a monitoring direction of the single detector to control the monitoring area to cover the alarm area;
switching a video camera from a standby state to an operation state; and
starting recording to obtain a first video;
maintaining the video camera in the operation state;
detecting whether the predefined event occurs in the alarm area; and
if occurrence of a predefined event in the alarm area is detected, taking a preset duration of the first video as a pre-recorded video of a second video; and
wherein the second video has a starting time that is the same as a time when the predefined event occurs in the alarm area.

2. The video pre-recording method according to claim 1, further comprising
storing the first video in a system buffer; and
writing the first video to a hardware storage medium when occurrence of the predefined event in the alarm area is detected.

3. The video pre-recording method according to claim 2, further comprising deleting the first video stored in the system buffer when disappearance of the predefined event from the alarm area is detected or the first video is written to the hardware storage medium.

4. The video pre-recording method according to claim 1, further comprising:
configuring a first detector to detect whether the predefined event occurs in the pre-alarm area, and
configuring a second detector to detect whether the predefined event occurs in the alarm area.

5. (canceled)

6. A video camera, comprising a detecting apparatus comprising a single detector, wherein
the video camera has a view finding area comprising an alarm area and a pre-alarm area;
the single detector is configured, in an initial state, to have a monitoring area covering the pre-alarm area;
the single detector is configured to detect whether a predefined event occurs in the alarm area and the pre-alarm area;
when occurrence of the predefined event in the pre-alarm area is detected;
the single detector is configured to adjust a monitoring view angle to control the monitoring area to cover the alarm area; and
the video camera is switched from a standby state to an operation state and starts recording to obtain a first video;
the video camera is maintained in the operation state,
the detecting apparatus detects whether the predefined event occurs in the alarm area; and
if occurrence of the predefined event in the alarm area is detected, the video camera takes a preset duration of the first video as a pre-recorded video of a second video; and
wherein the second video has a starting time that is the same as a time when the predefined event occurs in the alarm area.

7. The video camera according to claim 6, further comprising a hardware storage medium and a system buffer,
wherein the first video is stored in the system buffer; and
wherein the first video is written to the hardware storage medium when occurrence of the predefined event in the alarm area is detected.

8. The video camera according to claim 6, wherein the detecting apparatus comprises a first detector and a second detector;
wherein the first detector is configured to detect whether the predefined event occurs in the pre-alarm area; and
wherein the second detector is configured to detect whether the predefined event occurs in the alarm area.

9. (canceled)

10. An electronic device, comprising a memory and a processor, wherein:
the memory is configured to store a program; and
the processor is configured to execute the program to perform the video pre-recording method according to claim 1.

11. The electronic device according to claim 10, wherein the video pre-recording method further comprising:
storing the first video in a system buffer; and
writing the first video to a hardware storage medium when occurrence of the predefined event in the alarm area is detected.

12. The electronic device according to claim 11, wherein the video pre-recording method further comprising deleting the first video stored in the system buffer when disappearance of the predefined event from the alarm area is detected or the first video is written to the hardware storage medium.

13. The electronic device according to claim 10, wherein the video pre-recording method further comprising:
configuring a first detector to detect whether the predefined event occurs in the pre-alarm area; and
configuring a second detector to detect whether the predefined even occurs in the alarm area.

14. (canceled)
